(19) United States
(12) Patent Application Publication
(10) Pub. No.: US 2021/0276127 A1
(43) Pub. Date: Sep. 9, 2021

(54) BUTT WELDING OF TWO WORKPIECES WITH AN ULTRASHORT PULSE LASER BEAM, AND ASSOCIATED OPTICAL ELEMENTS

(71) Applicant: TRUMPF Laser- und Systemtechnik GmbH, Ditzingen (DE)

(72) Inventors: Malte Kumkar, Weimar (DE); Felix Zimmermann, Leonberg (DE)

(21) Appl. No.: 17/331,089

(22) Filed: May 26, 2021

Related U.S. Application Data
(63) Continuation of application No. PCT/EP2019/081787, filed on Nov. 19, 2019.

(30) Foreign Application Priority Data
Nov. 28, 2018 (DE) 102018220445.4

(51) Int. Cl. B23K 26/26; B23K 26/0622; B23K 26/06; B23K 26/08

(52) U.S. Cl. CPC B23K 26/26; B23K 26/0624; B23K 2103/54; B23K 26/0884; B23K 26/0604

(57) ABSTRACT

The present disclosure provides methods, devices, and systems for the butt welding of two, e.g., planar, workpieces, by at least one pulsed laser beam, e.g. an ultrashort pulse (“USP”) laser beam, which is focused into the workpiece material to locally melt the two workpieces in the region of their joining surface. The laser focus of the laser beam focused into the workpiece material is moved transversely with respect to the beam direction of the laser beam to produce in the region of the joining surface a weld seam extending transversely with respect to the beam direction of the laser beam.

### CROSS REFERENCE TO RELATED APPLICATIONS

This application is a continuation of and claims priority under 35 U.S.C. § 120 from PCT Application No. PCT/EP2019/081787, filed on Nov. 19, 2019, which claims priority from German Application No. 10 2018 220 445.4, filed on Nov. 28, 2018. The entire contents of each of these priority applications are incorporated herein by reference.

### TECHNICAL FIELD

The present disclosure relates to methods, devices, and systems for the butt welding of two, e.g., planar, workpieces, using at least one pulsed laser beam, e.g., ultrashort pulse (“USP”) laser beam which is focused into the workpiece material to locally melt the two workpieces in the region of their joining surface. The present disclosure further relates to elements joined together from at least two workpieces that are laser-welded to one another.

### BACKGROUND

USP laser radiation having pulse durations of less than 500 ps, e.g., in the femtoseconds range, is increasingly being used for material processing. An advantage of material processing using USP laser radiation resides in the short interaction time between the laser radiation and the workpiece. Because of this short interaction time, extreme thermodynamic imbalances can be produced in the workpiece, which then result in unique removal or formation mechanisms.

The laser welding of laser-transparent glasses or other materials that are transparent, partly transparent, or scattering vis-à-vis the laser beam (e.g. crystals, polymers, semiconductors, and ceramics using ultrashort laser pulses can create a stable connection without additional material use, but is limited by laser-induced transient and permanent stresses. For the butt welding of two laser-transparent workpieces, such as glasses or crystals, for example, a USP laser beam focused for example centrally into the thickness of the two workpieces is moved along the joining surface of the two workpieces to locally melt the two workpieces in the region of their joining surface and thereby to produce a continuous horizontal weld seam in the material of the two workpieces. The weld seam is typically formed by a melting zone, which is discernible from outside the workpieces as a welding bubble and which proceeds from the laser focus and extends in the shape of a drop counter to the direction of an incident laser beam. To increase the bonding area, a plurality of weld seams are placed next to one another in paths. This way of welding creates gas-tight weld seams and joining connections having high strengths and is used for joining, e.g., protective glasses.

### SUMMARY

The present disclosure is provides butt welding methods, devices, and systems using USP laser beams that further improve the welding result. For example, laser-transparent workpieces can be securely welded to one another even if one of the surfaces of the workpieces exhibits defects.

Local melting of material can be done by ultrashort laser pulses. For example, if ultrashort laser pulses are focused into a volume of glass, e.g., quartz glass, the high intensity present at the laser focus point results in non-linear absorption processes, whereby, depending on the laser parameters, different material modifications can be induced. These non-linear absorption processes generate excited charge carriers, which in consequence effect quasi-linear absorption. In this way, a plasma arises locally in the absorption region. The melting zone arises when a plurality of pulses (with a high repetition rate) are radiated into a workpiece with overlap, such that the induced heat accumulates and the material melts. After cooling, a permanent connection is made if the modification lies at the joining face of the joining workpieces. In this case, the actual weld seam (size of the melted region) is generally larger than the absorption region. If the modification is positioned in the region of the interface of two glasses, the cooling melt generates a stable connection between both glasses. Because of the localized joining process, the laser-induced stresses are typically low, as a result of which even glasses having greatly different thermal properties can be welded together. Moreover, other transparent materials such as crystals having, e.g., even more greatly deviating thermal and mechanical properties, can be welded to one another or to glass.

In one aspect, the disclosure provides methods for the butt welding of two, e.g., planar, workpieces. The methods include focusing at least one pulsed laser beam, e.g., a USP laser beam, into the workpiece material to locally melt the two workpieces in the region of their joining surface, wherein the laser focus of the laser beam focused into the workpiece material is moved transversely with respect to the beam direction of the laser beam to produce a weld seam in the region of the joining surface extending transversely with respect to the beam direction of the laser beam. In some embodiments, the USP laser beam comprises laser radiation having pulse durations of, e.g., less than 50 ps, less than 1 ps, in the femtoseconds range, or between 10 fs and 500 ps.

In some embodiments, the laser focus is moved longitudinally and/or transversely with respect to the joining surface. In this case, the beam direction of the laser beam is, for example, parallel to the joining surface and/or at right angles to the workpiece top side. In certain embodiments the geometry of the laser beam is coordinated with the corresponding workpiece geometry and can be spatio-temporally shaped. This makes it possible to avoid shading or deficient coupling-in of energy, for example, due to defects in the material.

In addition, the present disclosure makes it possible to weld thick planar workpieces to one another. The workpieces can be formed from, e.g., glass, quartz glass, polymer, glass ceramic, crystals, or combinations thereof and/or with opaque materials. The workpieces can also have coatings that would not allow direct irradiation through the workpieces.

Some embodiments include a transverse movement of the laser focus, i.e., the laser focus is moved transversely across the joining surface. As a result, the melt induced in the focus region is driven into the joining zone and, after cooling, results in a permanent connection between the two workpieces. It is possible to focus into the joining surface directly or in proximity and to carry out the welding process while advancing along the joining surface, e.g., along the joining line on the top side. It is also possible to move the laser focus simultaneously longitudinally and transversely with respect to the joining surface to form in the region of the joining surface, for example, a non-rectilinear weld seam, the shape of which results from the superimposed transverse and longitudinal movement of the laser focus.

In certain embodiments, the beam profile of the incident laser beam is spatially and/or temporally adapted. This means, for spatial beam profiles, for example, that a Gaussian beam profile can be used or the beam profile can be adapted such that a spatial beam profile is chosen that has significant beam portions outside the optical axis, e.g., including two focal points offset with respect to the optical axis. A further possibility for spatially adapting the beam profile is, for example, to radiate in the laser beam obliquely with respect to the joining surface and/or with respect to the workpiece top side. One example of the temporal adaptation of the beam profile involves, for example, radiating in the pulsed laser beam in temporal intervals. These may be short pulse trends or bursts. Better coupling-in of energy can be achieved as a result.

A further example of a temporal and spatial adaptation of the beam profile of the incident laser beam involves irradiating a joining surface with a plurality of laser beams that are offset with respect to one another and transversely with respect to the beam direction. The plurality of laser beams can be offset in parallel with respect to one another and transversely with respect to the beam direction, for example, with the result that individual or continuous welding regions are produced and a larger area can be welded at the same time and/or a larger longitudinal melting modification arises, which makes possible a larger focus position tolerance. In this case, the laser foci of the plurality of laser beams can be offset one behind another in the beam direction to minimize possible defects at the workpiece surface or at the joining surface. However, in some implementations, the plurality of laser beams does not run offset in a parallel fashion, rather their beam axes can advantageously converge in the workpiece to bypass possible defects. In this case, the plurality of laser beams are moved jointly in a direction that runs transversely with respect to their respective beam directions.

In some embodiments, the adaptation of the beam profile is adapted to the conditions of the workpieces. For example, it is possible to localize the extent of the melting zones for the melting of workpieces with possible hardening layers in a lateral direction of the hardening layers or in the direction of stress gradients, perpendicular to the hardening zones.

The spatial and/or temporal adaptation of beam profiles to the conditions of the workpieces makes it possible to avoid or reduce, for example shading, e.g., as a result of total reflection at gaps or transitions in the joining surface of the workpieces. It is likewise possible to reduce or avoid aberration-dictated losses, which could arise, for example, in the event of spherical aberrations in the case of offset interfaces of the workpieces with respect to one another.

The laser beam can be modulated, for example, by a spatial light modulator or an acousto-optical deflector (AOD). The AOD modulation can be varied highly dynamically during the welding process. The absorption region of the laser beam in the workpieces can be varied actively by beam shaping elements such as, e.g., diffractive optical elements, spatial light modulators, and/or by acousto-optical deflectors.

A temporal absorption dynamic characteristic can be effected by radiating in the laser beam in temporal intervals, for example, by short laser pulse trains so-called “bursts.” As a result, it is possible to vary not only the absorption and/or melting geometry, but also a cooling dynamic characteristic to modify, e.g., the cooling rate and the final fictive temperature of the material.

In a further aspect, the present disclosure relates to optical elements defined by at least two workpieces joined together by the new butt welding methods described herein. The workpieces are welded to one another by at least one weld seam in the region of the joining surface. The weld seam runs in a longitudinal direction and/or in a transverse direction with respect to the joining surface.

Further advantages and advantageous configurations of the subject matter of the invention are evident from the description, the claims and the drawings. Likewise, the features mentioned above and those presented further below can each be used by themselves or as a plurality in any combinations. The embodiments shown and described should not be understood as an exhaustive enumeration, but rather are of exemplary character for outlining the invention.

### DESCRIPTION OF DRAWINGS

FIG. 1 is a schematic diagram of a laser processing machine for butt welding two workpieces together using a laser beam, as described herein.

FIGS. 2A-2C are a series of schematic diagrams of a sectional view of two planar workpieces that are welded to one another by a Gaussian laser beam, the laser focus of which is moved transversely with respect to the joining surface (FIG. 2A), parallel to the joining line on the top side (FIG. 2B), and transversely with respect to the joining surface and parallel to the joining line on the top side (FIG. 2C); and

FIGS. 3A-3C are a series of schematic diagrams of a sectional view of two planar workpieces that are welded to one another by an inclined, Gaussian laser beam (FIG. 3A), a ring-shaped laser beam (FIG. 3B), and three Gaussian laser beams (FIG. 3C) running parallel next to one another.

### DETAILED DESCRIPTION

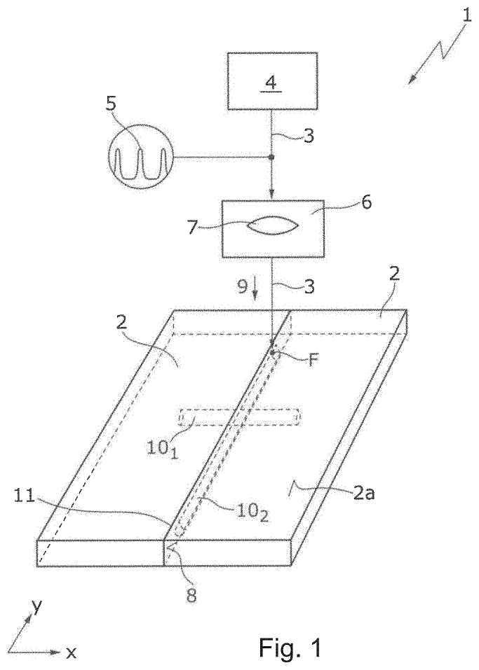

The laser processing machine 1 shown in FIG. 1 serves for the butt welding of two planar workpieces 2 bearing against one another in a butt joint, by means of a laser beam 3. The two workpieces 2 are formed for example from glass, quartz glass, polymer, glass ceramic, crystals, or from combinations thereof, and/or with opaque materials, and/or are coated therewith.

The laser processing machine 1 includes a USP laser 4 for generating the laser beam 3 in the form of USP laser pulses 5 having pulse durations of less than 500 ps, e.g., in the form of femtosecond pulses, and a laser processing head 6, which is movable in X-Y-Z-directions and has a focusing optical unit 7 for focusing the laser beam 3 emerging at the bottom of the laser processing head 6. Alternatively or additionally, the assembly composed of the two workpieces 2 that are to be welded can also be moved in X-Y-directions.

The focusing optical unit 7 can spatially and/or temporally adapt the beam profile of the laser beam 3. For this purpose, the focusing optical unit 7 can comprise, e.g., a spatial light modulator and/or acousto-optical deflectors (AOD). In the focusing optical unit 7, the absorption region can be actively adapted, for example by beam shaping elements, e.g., diffractive optical elements, spatial light modulators or AOD. This can also take place highly dynamically during the butt welding itself. As an alternative or in addition to the temporal modulation of the pulse parameters or to the generation of pulse trains directly from the laser, the focusing optical unit 7 can additionally modify the temporal absorption dynamic characteristic by short laser pulse trains or bursts, and thereby vary the absorption and/or melting geometry directly or vary the melting geometry indirectly by an adapted cooling dynamic characteristic. The indirect adaptation of the cooling dynamic characteristic may, for example, necessitate adapting the cooling rate such that the final fictive temperature of the glass is modified under the influence of the density change and thus the induced stress. The laser beam 3 can be offset relative to the optical axis by means of the focusing optical unit 7.

During the butt welding of the two workpieces 2, the laser beam 3 is directed at right angles or virtually at right angles towards the workpiece top side 2a facing the laser processing head 6 and is focused into the workpiece material in the region of the common joining surface 8 of the two workpieces 2 to locally melt the two workpieces 2 in the region of the joining surface 8. In this case, the laser focus F of the laser beam 3 is moved at right angles to the beam direction 9 of the laser beam 3 to produce in the region of the joining surface 8 a weld seam 10₁, 10₂ extending at right angles to the beam direction 9 of the laser beam 3. In this case, the weld seam can extend transversely with respect to the joining surface 8 (transverse seam 10₁) or longitudinally or parallel with respect to the top-side joining line 11 of the two workpieces 2 (longitudinal seam 10₂). In the case of the longitudinal movement, the laser focus F can be situated in the material of one of the two workpieces 2 at the joining surface 8 or in proximity to the joining surface 8. In the case of the transverse movement, the laser focus F moves from the workpiece material of one workpiece 2 into the workpiece material of the other workpiece 2 and passes through the joining surface 8 in the process. A combined longitudinal and transverse movement of the laser focus is also possible in order thus to produce for example a weld seam in the shape of a wavy line or zigzag.

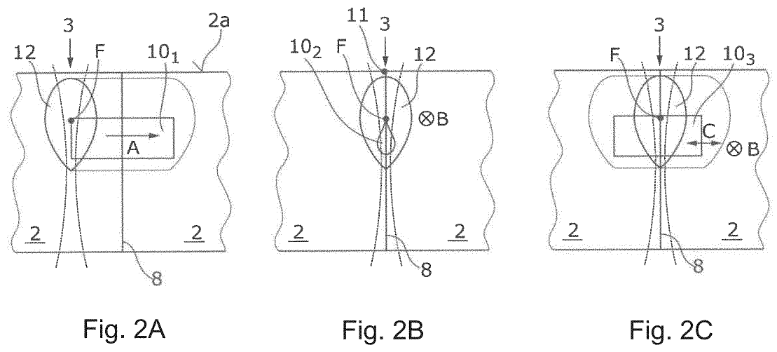

FIGS. 2A-2C each show a sectional view of two planar workpieces 2 which are welded to one another by a pulsed laser beam 3 having e.g. a Gaussian beam profile. The laser beam 3 is radiated in parallel to the joining surface 8 and at right angles onto the workpiece top side 2a. The laser beam 3 focused into the workpiece material melts a melting zone 12 in the shape of a drop in the workpiece material around the laser focus F.

In FIG. 2A, the laser focus F is moved at right angles to the joining surface 8 in direction A and across the joining surface 8 to produce a weld seam 10₁ running across the joining surface 8. Instead of the shown linear transverse movement of the laser beam 3 in direction A, the laser beam 3 can also be rotated about an axis parallel to its direction of incidence to produce a ring-shaped weld seam which intersects the joining surface 8 twice. As a further alternative, the laser beam 3, in addition to its shown linear transverse movement in direction A, can also be rotated about an axis parallel to its direction of incidence to produce a cycloidal weld seam or a wider weld seam that intersects the joining surface 8.

In FIG. 2B, the laser focus F is moved parallel to the joining line 11 on the top side in direction B to produce in the region of the joining surface 8 a weld seam 10₂ running along the joining surface 8.

In FIG. 2C, the laser focus F is both moved back and forth (double-headed arrow C) in an oscillating manner at right angles to the joining surface 8 and moved parallel to the joining line 11 on the top side and in the direction B to produce a weld seam 10₃ in the shape of a wavy line or zigzag, for example, in the region of the joining surface 8. Instead of the translational transverse movement of the laser beam 3 in direction A, the laser beam 3 can also be pivoted back and forth in an oscillating manner or be rotated about an axis parallel to its direction of incidence. In the latter case, the rotation of the laser beam 3 superimposed on the linear advance movement produces a cycloidal weld seam or a wide weld seam in direction B.

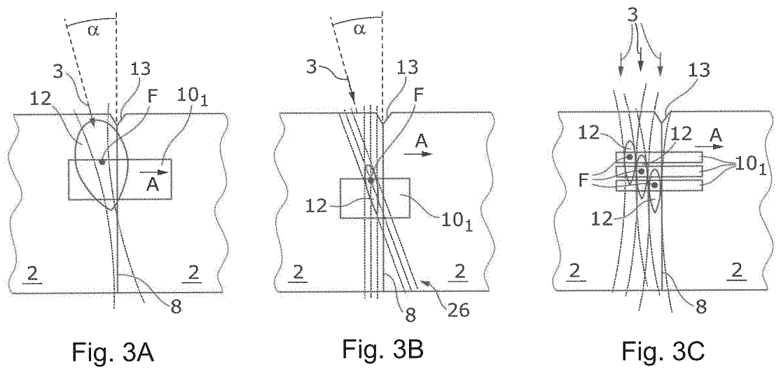

FIG. 3A differs from FIG. 2A in that here the laser beam 3 is radiated in obliquely with respect to the joining surface 8 and with respect to the workpiece top side 2a and is moved transversely with respect to the beam direction of the laser beam 3 in direction A. The angle α between laser beam 3 and joining surface 8 is e.g. 10° to 20°. This inclined laser beam 3 makes it possible to bypass possible defects 13 at the workpiece surface 2a or at the joining surface 8 and nevertheless to achieve a good welding result. Instead of the shown translational transverse movement of the laser beam 3 in direction A, the inclined laser beam 3 can also be pivoted back and forth in an oscillating manner or be rotated about an axis parallel to its direction of incidence.

FIG. 3B differs from FIG. 3A in that here the laser beam 3 has a beam profile based on a ring-shaped angular distribution, e.g. a Bessel shape. This beam profile or the Bessel shape has significant beam portions outside the optical axis of the laser beam 3. As a result, it is possible to minimize the effect of possible defects 13 at the workpiece surface 2a or at the joining surface 8 and to achieve a good welding result. The laser beam 3, instead of being radiated in obliquely as in FIG. 3B, can also be radiated in at right angles onto the workpiece top side 2a as in FIG. 2A. In that case, too, the disturbing influence of surface defects 13 at the butt joint is reduced (albeit not in the full angular range).

FIG. 3C differs from FIG. 2A in that here a plurality of, e.g., three, pulsed laser beams 3 having an e.g. Gaussian beam profile are radiated in. The laser beams 3 are offset parallel with respect to one another in direction 3, and their laser foci F are offset one behind another in the beam direction 9. The laser beams 3 are moved across the joining surface 8 at right angles to the joining surface 8 jointly in direction A to produce a plurality of weld seams 10₁ offset parallel in the depth direction. This plurality of laser beams 3 likewise makes it possible to obtain good welding results, even in the event of defects 13 being present in the workpieces 2.

Instead of the translational transverse movement of the laser beam 3 in direction A as shown in FIGS. 3A to 3C, the inclined laser beam 3 in FIGS. 3A and 3B and respectively the plurality of laser beams 3 can also be pivoted back and forth in an oscillating manner or be rotated about an axis parallel to the direction of incidence.

In addition to the transverse and longitudinal movements of the laser beam 3 as shown in FIGS. 2A-2C and 3A-3C, the laser focus F of the laser beam 3 can also be moved in and counter to the beam direction in order thus to produce a weld seam that varies in the workpiece depth.

### OTHER EMBODIMENTS

A number of embodiments of the present disclosure have been described. Nevertheless, it will be understood that various modifications may be made without departing from the spirit and scope of the present disclosure. Accordingly, other embodiments are within the scope of the following claims.

What is claimed is:

1. A method for butt welding two workpieces, the method comprising
focusing at least one ultrashort pulse laser beam into the two workpieces to locally melt the two workpieces in a region of a joining surface; and
moving a laser focus of the pulsed laser beam transversely with respect to a beam direction of the laser beam to produce in the region of the joining surface a weld seam extending transversely with respect to the beam direction of the laser beam.

2. The method of claim 1, further comprising moving surfaces of the two workpieces to be joined into contact along a joining surface.

3. The method of claim 1, wherein the pulsed laser beam is directed in parallel to the joining surface, or at right angles to a top side of the workpieces, or both.

4. The method of claim 1, wherein the laser focus of the laser beam focused into the two workpieces is moved longitudinally, or transversely, or both longitudinally and transversely, with respect to the joining surface to produce the weld seam in the region of the joining surface.

5. The method of claim 1, wherein the laser beam has a Gaussian beam profile or a beam profile based on a ring-shaped angular distribution.

6. The method of claim 5, wherein the laser beam has a Bessel shaped beam profile.

7. The method of claim 1, wherein the laser beam is directed obliquely with respect to a top side of the workpieces, or with respect to the joining surface, or both.

8. The method of claim 1, wherein a plurality of laser beams that are offset with respect to one another, are focused into the two workpieces in the region of the joining surface.

9. The method of claim 8, wherein the plurality of laser beams are offset transversely with respect to the beam direction and parallel with respect to one another.

10. The method of claim 8, wherein laser foci of the plurality of laser beams are offset one behind another in the beam direction.

11. The method of claim 8, wherein a repetition rate of at least one of the pulsed laser beams is between 1 kHz and 500 GHz.

12. The method of claim 1, wherein a pulse duration of the pulsed laser beam is between 10 fs and 500 ps.

13. The method of claim 1, wherein to produce a transverse movement, the laser beam is pivoted back and forth in an oscillating manner or is rotated about an axis parallel to a direction of incidence.

14. The method of claim 1, wherein the laser focus of the laser beam is moved in the beam direction, counter to the beam direction, or both.

15. The method of claim 1, wherein the pulsed laser beam comprises an ultrashort pulse laser having pulse durations of less than 50 ps.

16. An element formed from at least two planar workpieces which are laser-welded to one another and which are joined together at at least one joining surface, comprising at least one weld seam in the region of the joining surface, which runs in a longitudinal direction and/or in a transverse direction with respect to the joining surface.
